(19) United States
(12) Patent Application Publication
(10) Pub. No.: US 2020/0090555 A1
(43) Pub. Date: Mar. 19, 2020

(54) WORKSITE WARNING LABEL SYSTEM

(71) Applicant: Jason E. Smith, MORRIS, IL (US)

(72) Inventor: Jason E. Smith, MORRIS, IL (US)

(21) Appl. No.: 16/560,952

(22) Filed: Sep. 4, 2019

Related U.S. Application Data
(60) Provisional application No. 62/726,944, filed on Sep. 4, 2018.

(51) Int. Cl. G09F 3/14; G09F 3/02; G09F 3/10; G09F 3/20

(52) U.S. Cl. CPC G09F 3/14; G09F 3/02; G09F 2003/0202; G09F 3/201; G09F 3/10

(57) ABSTRACT

A custom warning-label system; the system includes an apparatus and a method of use relating to custom warning-labels useable to modify worksite safety devices. The warning label is attachable to construction barrels, cones, and similar barriers. The system is designed to alert users to specific hazards present around the worksite.

### CROSS REFERENCE TO RELATED APPLICATION

The present application is related to and claims priority to U.S. Provisional Patent Application No. 62/726,944 filed 2018 Sep. 4, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of portable signs or signals specially adapted for fitting to portable barriers and more specifically relates to custom warning-labels for worksite safety devices.

### 2. DESCRIPTION OF RELATED ART

Safety barrels or cones may be used to cover open holes and other hazards at a construction site, worksite, etc. These worksite safety devices are commonly supplied in bright colors to increase visibility. Unfortunately, it is also common to see playground equipment for children supplied in similar bright colors and patterns. For this reason, young children have been known to confuse worksite safety devices as play features. Children may be attracted to and play on the worksite safety devices unaware of the dangers associated with doing so. Without a specific warning label, children may continue to play on these devices at considerable risk. Even parents or guardians are often unaware of the level of risk associated with the hazard. Furthermore, pedestrians of any age can fall into the holes, become trapped, or be seriously injured when such hazards are not clearly identified. A suitable solution is needed.

Prior warning devices have been attempted. For example, U.S. Pat. No. 5,090,349 to David L. Wilson relates to a traffic safety cone. The described traffic safety cone includes a folding warning marker device with multiple panels formed from a sheet of cardboard or other folding material. For exemplary purposes, the disclosed invention is shown as a four-sided truncated cone having various warning indicia on the surface. It is characterized by ease of stacking and storage and toward that end can be stored in a flat layout condition. Disposed at the top of the cone is a vertical slit on opposing sides allowing for the insertion of a ribbon fence from one safety cone to the next thereby cordoning off an area of danger. The top of the truncated cone is characterized by a flap that folds over the slits in order to thus fasten the ribbon passing through to the safety cone. The bottom of the safety cone is characterized by folding flaps thus forming a base of a cone and thus securely holding the structure in place. Unfortunately, the above-noted reference fails to provide the structures and arrangements necessary to modify existing worksite safety devices. Moreover, the above-noted reference fails to disclose the providing of information relating to specific worksite hazards, owner contact information, or combinations of both.

### BRIEF SUMMARY OF THE INVENTION

In view of the foregoing disadvantages inherent in the known portable signs or signals specially adapted for fitting to portable barriers art, the present disclosure provides a novel worksite warning-label system. The general purpose of the present disclosure, which will be described subsequently in greater detail, is to provide an apparatus and method of use relating to custom warning-labels useable to modify worksite safety devices.

A custom warning-label system is disclosed herein. The custom warning-label system may include a custom warning-label usable to modify a worksite safety device to display safety information relating to a worksite hazard, the worksite safety device may include a warning label, the warning label including a display member configured to display the safety information; a protective cover configured to protectively cover the display member, and an elastic attachment member configured to elastically attach the warning label to the worksite safety device; and a set of instructions, wherein the custom warning-label is arranged as a kit. Wherein the elastic attachment member is configured to elastically attach the warning label to a worksite safety device including at least one of a traffic cone, a safety barrel, a portable barricade; and wherein the safety information includes text warning of the worksite hazard; and the text contains contact information. Even further, the custom warning-label may include an adhesive to assist adhering the warning label to the worksite safety device. Even further, the protective cover of the custom warning-label may include a transparent wall of a pocket, wherein the pocket may be adapted to removably receive a sheet containing the safety information. Even further, the safety information of the warning-label may be applied on the display member using a printing process.

A method of using the custom warning label of the custom warning label system is also disclosed herein. The method of using the custom warning label may include the steps of: identifying a worksite hazard; providing a warning label configured to display safety information relating to the worksite hazard, the warning label including a display member configured to display the safety information, a protective cover configured to protectively cover the display member, and an elastic attachment member configured to elastically attach the warning label to the worksite safety device; and attaching the warning label to the worksite safety device.

Moreover, the method may further include the step of configuring the elastic attachment member to elastically attach the warning label to a worksite safety device including at least one of a traffic cone, a safety barrel, and a portable barricade. Additionally, the method may further include the step of forming the display member from a flexible sheet material. Also, the method may include the step of arranging the display member to include a pocket, wherein the protective cover may include a transparent wall of the pocket and the pocket may be adapted to removably receive a sheet containing the safety information. In addition, the method may further include the step of configuring the safety information to include at least one pictographic logo depicting the worksite hazard. And, the method may include the step of configuring the safety information to include text warning of the worksite hazard. Further, the method may include the step of providing the text in multiple languages. Even further, the method may include the step of providing contact information within the safety information. Moreover, the method may further include the step of applying the safety information on the display member using a printing process. Additionally, the method may include the step of applying the safety information on the display member by an etching process. Also, the method may include the step of forming the protective cover from a flexible transparent sheet. In addition, the method may include the step of forming the protective cover from a fluid-applied transparent coating. And, the method may include the step of applying an adhesive to the warning label to assist adhering the warning label to the worksite safety device. Further, the method may include the step of providing an illuminated element within the warning label.

Even further, the method may further include the step of: providing a website operable on a computer network, the website including a user interface adapted to enable user entry of the custom safety information, user entry of the type of worksite safety device, and user entry of order transaction information; providing a host computer operable within the computer network, the host computer adapted to receive the custom safety information, the type of worksite safety device, and the order transaction information from the website; initiating production of the warning label containing the custom safety information and the elastic attachment member usable attach the warning label to the type of worksite safety device selected; and completing the order transaction defined by the order transaction information received from the client computer system. Even further, the method may include the step of applying the safety information directly to the worksite safety device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a worksite warning-label system, constructed and operative according to the teachings of the present disclosure.

FIG. 1 is a perspective view of the custom warning-label system during an ‘in-use’ condition, according to an embodiment of the disclosure.

FIG. 2 is a side view of the custom warning-label system of FIG. 1 attached to a worksite safety device, according to an embodiment of the present disclosure.

FIG. 3 is a front view of a custom warning label of the custom warning-label system of FIG. 1, according to an embodiment of the present disclosure.

FIG. 4 is a front view of an alternate custom warning label of the custom warning-label system of FIG. 1, according to an embodiment of the present disclosure.

FIG. 5 is a front view of an alternate custom warning label of the custom warning-label system of FIG. 1, according to an embodiment of the present disclosure.

FIG. 6 is an exploded perspective view of the custom warning label of the custom warning-label system of FIG. 1, according to an embodiment of the present disclosure.

FIG. 7 is a front view of another custom warning label of the custom warning-label system, according to an embodiment of the present disclosure.

FIG. 8 is a diagram illustrating the application of the custom warning-label system to various worksite safety devices, according to an embodiment of the present disclosure.

FIG. 9 is a flow diagram illustrating a method of use of the custom warning-label system, according to an embodiment of the present disclosure.

FIG. 10 is a diagram illustrating a method of using the warning-label system to produce custom warning labels, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a portable signs or signals specially adapted for fitting to portable barriers and more particularly to a worksite warning-label system as used to improve the custom warning-labels for worksite safety devices.

Generally, the present disclosure is a warning label for construction barrels, cones, or similar barriers designed to alert users to hazards present around the worksite. The product may include contact information printed or etched on the label, allowing pedestrians to contact the foreman, manager, owner, etc. should safety hazards be present. It utilizes an elastic material capable of being wrapped or hung around the cone or barrel, firmly securing the label and preventing movement even during inclement weather. The device features a protective cover over the label and may further allow the label to be stamped or etched directly onto the barrel or cone. The present invention offers a way to conveniently improve safety on construction sites, maintenance sites, and more. As above, the label may be applied via an adhesive and covered with a protective material. Additionally, the label may be etched or stamped onto the barrel or cones. There may also be an elastic material that can wrap around the cone or barrel or hung from the top. The label features several warnings and contact information with the owner, foreman, manager, etc. The label is intended to improve safety near the cones and barrels and ward off pedestrians.

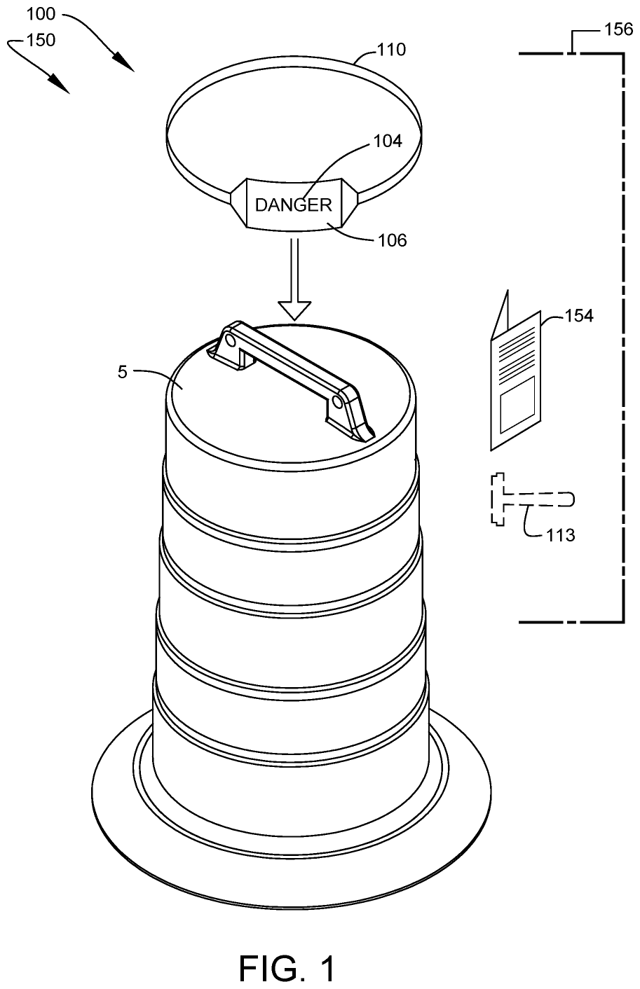

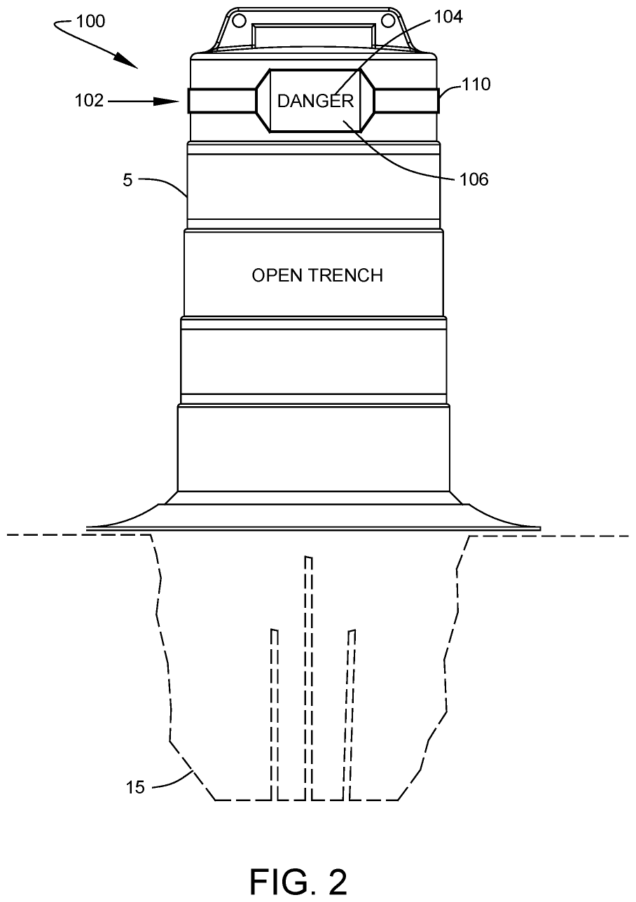

Referring now more specifically to the drawings by numerals of reference, there is shown in FIGS. 1-8, various views of a custom warning-label system 100 usable to modify a worksite safety device 5 to display safety information 104 relating to one or more worksite hazards. FIG. 1 shows a warning label assembly 102 of the custom warning-label system 100, according to an embodiment of the present disclosure. FIG. 2 is a side view of the warning label assembly 102 of FIG. 1 during an ‘in-use’ condition 150, according to an embodiment of the present disclosure. In the depiction of FIG. 2, the warning label assembly 102 has been attached to the worksite safety device 5. As illustrated, the warning label assembly 102 may include a display member 106 configured to display the safety information 104 and an elastic attachment member 110 structured and arranged to elastically attach the warning label assembly 102 to the worksite safety device.

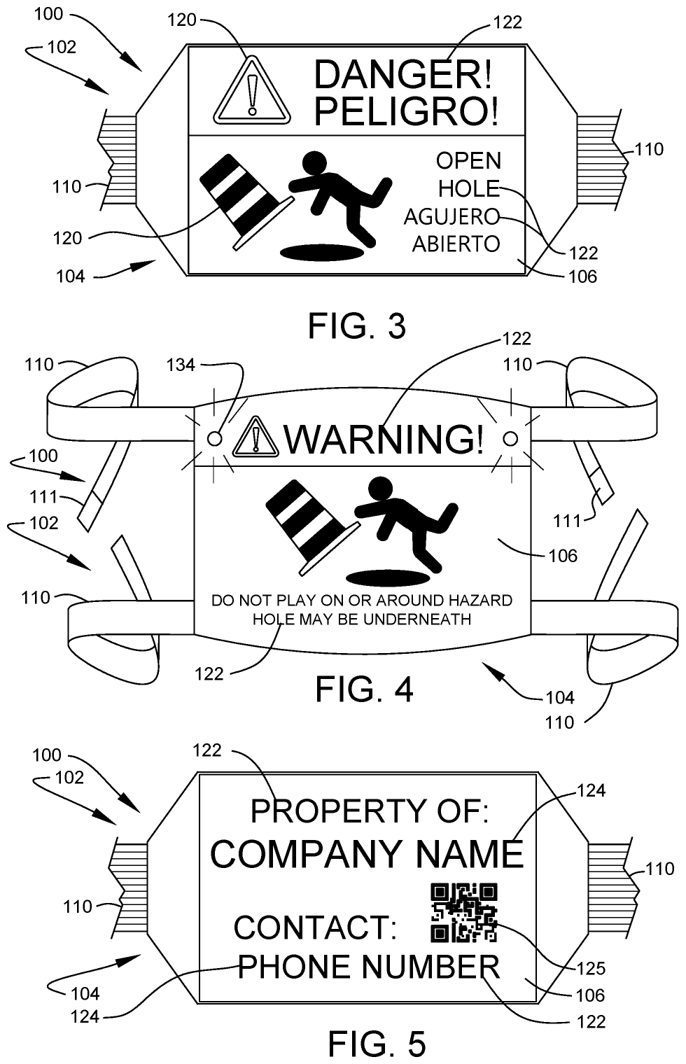

FIG. 3 through FIG. 5 illustrate various embodiments of the custom warning label assembly 102. FIG. 3 is a front view of a custom warning label assembly 102 of the custom warning-label system 100 of FIG. 1, according to one embodiment of the present disclosure. FIG. 4 is a front view of an alternate custom warning label assembly 102 of the custom warning-label system 100 of FIG. 1, according to another embodiment of the present disclosure. FIG. 5 is a front view of another custom warning label assembly 102 of the custom warning-label system 100 of FIG. 1, according to an alternate embodiment of the present disclosure.

In specific reference to FIG. 3, the display member 106 may be configured to display safety information 104 selected to alert individuals to specific hazards 15 (see FIG. 2) present around the worksite. In the example of FIG. 3, the safety information 104 may include at least one pictographic logo 120 depicting the worksite hazard 15. In addition, the safety information 104 may be configured to include text 122 warning of the worksite hazard. Furthermore, the text 122 may be provided in multiple languages, as shown.

The display member 106 may include a single elastic attachment member 110, as shown. The elastic material forming the elastic attachment member 110 is capable of being wrapped or hung around the worksite safety device 5, firmly securing the label and preventing movement even during inclement weather. The elastic attachment member 110 may be supplied in differing lengths. More specifically, the elastic attachment member 110 may be supplied in a size configuration allowing for secure attachment of the custom warning label assembly 102 to a selected worksite safety device 5.

The custom warning label assembly 102 may include a single elastic attachment member 110, as shown. Alternately, the custom warning label assembly 102 may include multiple elastic attachment members 110, as illustrated in FIG. 4.

In the depicted embodiment of FIG. 4, the custom warning label assembly 102 includes multiple elastic attachment members 110. Each elastic attachment member 110 may include a hook-and-loop fastener 111 to allow the ends of two of the elastic attachment members 110 to be releasably-joined together. Upon reading this specification, it should be appreciated that, under appropriate circumstances, considering such issues as user preferences, design preference, structural requirements, marketing preferences, cost, available materials, technological advances, etc., other attachment arrangements such as, for example, buckles, snaps, ties, magnets, adhesives, etc., may be sufficient.

In the depicted embodiment of FIG. 4, the display member 106 includes alternate safety information 104. An advantage of the present system is the ability to customize the content of the safety information 104, as shown. This allows any existing worksite safety device 5 to be modified to include specific safety information 104 relating to a worksite hazard. In some arrangements of the present disclosure, an illuminated element 134 may be provided within the warning label assembly 102, as shown. In addition, the safety information 104 may include contact information, as shown in FIG. 5.

FIG. 5 shows display member 106 containing contact information 124. The contact information 124 may allow individuals to contact the foreman, manager, owner, etc., should an issue relating to the hazard arise. The contact information may include a phone number, a scannable matrix barcode 125, Quick Response Code (QR Code), or similar identifying content. Upon reading this specification, it should be appreciated that, under appropriate circumstances, considering such issues as user preferences, design preference, structural requirements, marketing preferences, cost, available materials, technological advances, etc., other text arrangements such as, for example, alternate workplace-safety text, fire safety text, ISO safety text, electrical safety text, machine-safety text, first-aid text, NFPA text, noise-warning text, ANSI-warning text, hazardous-materials text, confined-space text, biohazard text, radiation-danger text, traffic-control text, bar codes, RFID devices, etc., may be sufficient.

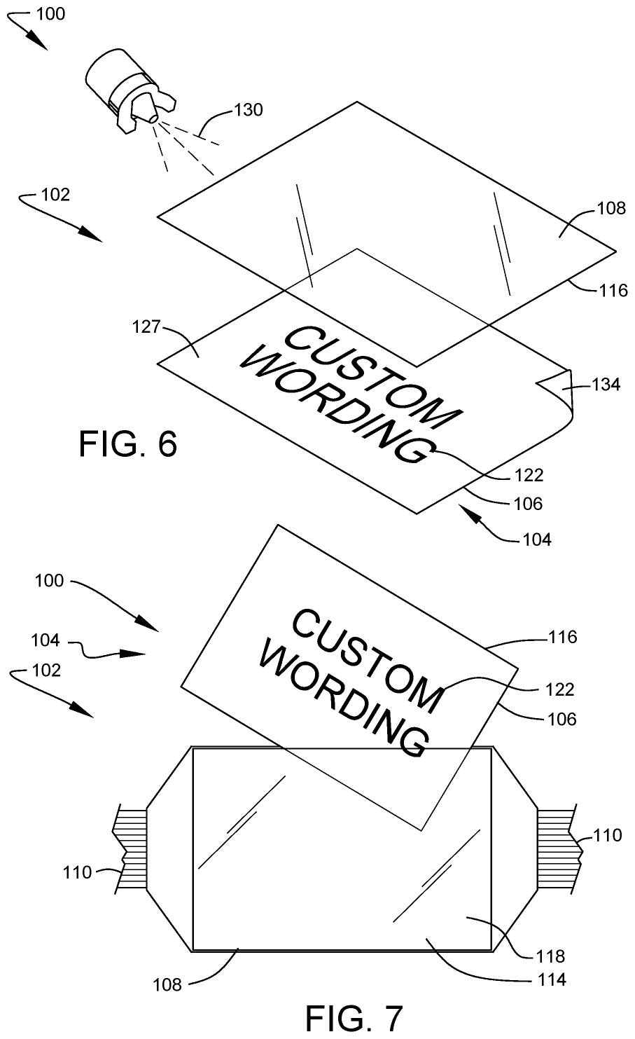

FIG. 6 is an exploded perspective view illustrating the construction of the custom warning label assembly 102, according to an embodiment of the present disclosure. The display member 106 may include a substrate 127 and a transparent protective cover 108 configured to protectively cover the substrate 127 of the display member 106. The safety information 104 may be applied to the display member 106 using at least one printing process. Printing processes may include digital printing, flexography, reprographics, screen printing, offset lithography, gravure, etc. The substrate 127 may be constructed of any printable material including paper, cardstock, sheet plastic, and the like. The substrate 127 may be a flexible sheet material, a semi-flexible material, or rigid material, as required.

Alternately, the safety information 104 may be applied to the display member 106 using at least one engraving process. In this embodiment, the safety information 104 may be engraved, etched, inscribed, cut, incised, chiseled, scored, notched, or impressed into the surface of the substrate 127. The substrate 127 may be constructed of any engravable material including sheet plastic, metals, ceramics, composites, and the like. The substrate 127 may be flexible, semi-flexible, or rigid, as required. Upon reading this specification, it should be appreciated that, under appropriate circumstances, considering such issues as user preferences, design preference, structural requirements, marketing preferences, cost, available materials, technological advances, etc., other marking arrangements such as, for example, hand-written text, digital displays, etc., may be sufficient.

The protective cover 108 may be constructed from a flexible transparent sheet 116. Alternately, the protective cover 108 may be a fluid-applied transparent coating 130. The fluid-applied transparent coating 130 may be roll applied, dipped, or spray applied, as shown.

In some implementations of the present disclosure, the warning label assembly 102 may further include an adhesive 132 to assist adhering the warning label assembly 102 to the worksite safety device 5. In this arrangement, the warning label assembly 102 may be adhered directly to the worksite safety device 5. Although the system is primarily intended to be a temporary modification, the adhesive 132 may be used to permanently attach the warning label assembly 102. Furthermore, the system may utilize other permanent marking arrangements. For example, the custom warning-label system 100 may be arranged as a kit 156, as shown in FIG. 1. The kit 156 may include the warning label assembly 102 and may also include a tool 113 to permanently marking a worksite safety device 5 with safety information 104. The kit 156 may further include a set of instructions 154. The instructions may detail functional relationships in relation to the structure of the custom warning-label system 100 (such that the custom warning-label system 100 can be applied, maintained, or the like, in a preferred manner).

FIG. 7 is a front view of another custom warning label assembly 102 of the custom warning-label system 100, according to another embodiment of the present disclosure. In the implementation of FIG. 7, the protective cover 108 may be a transparent wall 118 of a pocket 114. The pocket 114 may be adapted to removably receive a sheet 116 containing the safety information 104.

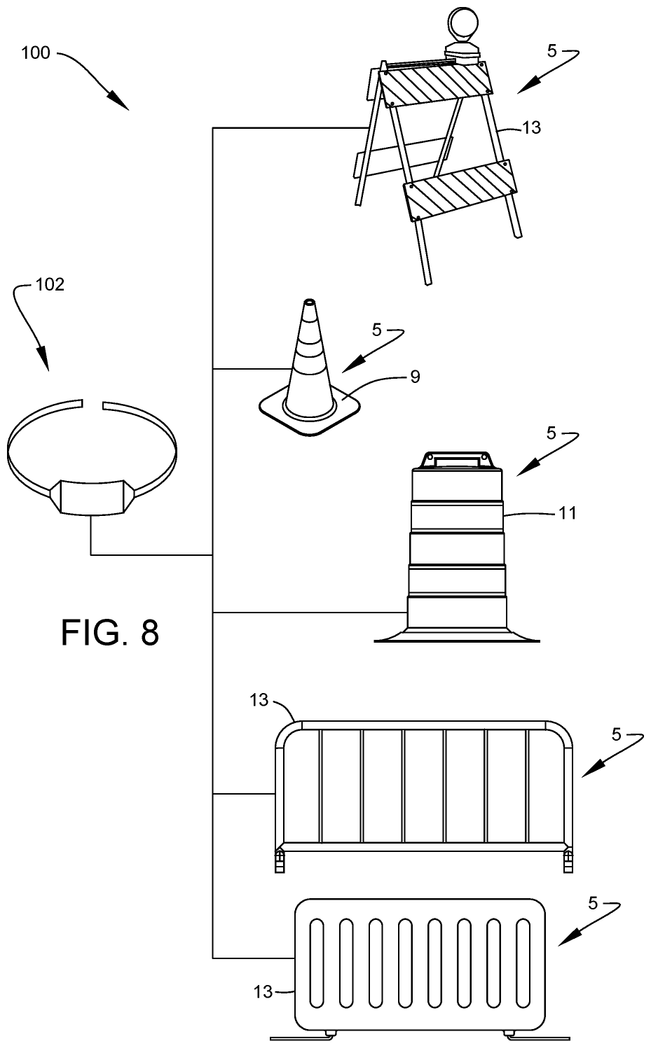

FIG. 8 is a diagram illustrating the application of the custom warning-label system 100 to various worksite safety devices 5, according to an embodiment of the present disclosure. More specifically, the custom warning-label system 100 may be adapted to be attachable to traffic cones 9, safety barrels 11, portable barricades 13, and the like. Upon reading this specification, it should be appreciated that, under appropriate circumstances, considering such issues as user preferences, design preference, structural requirements, marketing preferences, cost, available materials, technological advances, etc., adapting the system to other types of safety devices such as, for example, other barrel types, jersey barriers, other traffic cones, mobile delineators, other barricade devices, warning stations, commercial products, etc., may be sufficient.

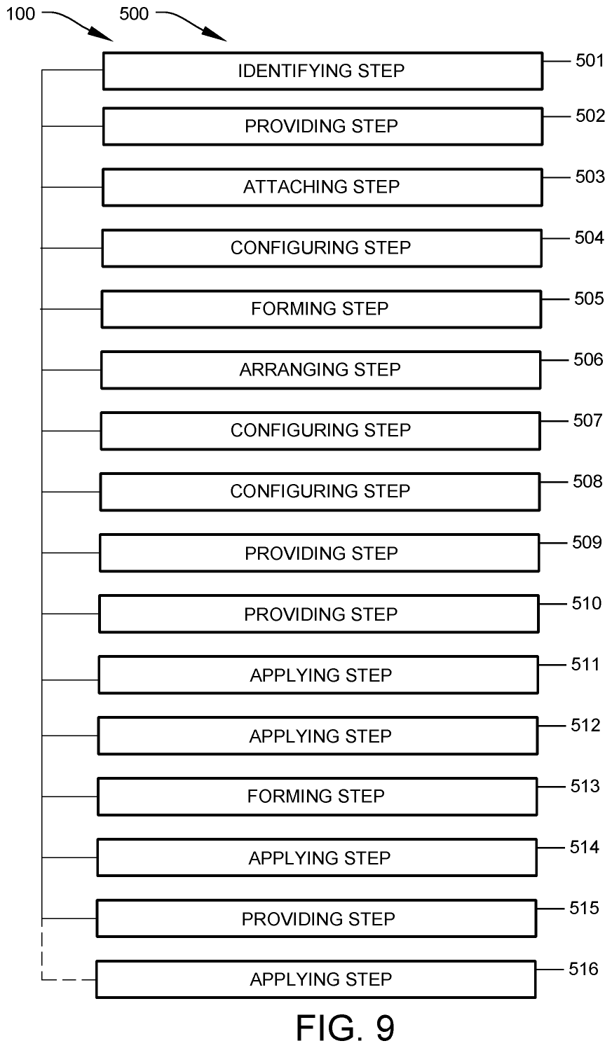

FIG. 9 is a flow diagram illustrating a method 500 relating to providing and using a custom warning-label system useable to modify a worksite safety device 5, according to an embodiment of the present disclosure. As illustrated, the method 500 may include the steps of: step one 501, identifying a worksite hazard 15. The worksite hazard 15 may be an open hole, an open trench, or the like. The method 500 may include step two 502, providing a warning label assembly 102 configured to display safety information 104 relating to the worksite hazard 15, the warning label assembly 102 comprising a display member 106 configured to display the safety information 104, a protective cover 108 configured to protectively cover the display member 106, and an elastic attachment member 110 configured to elastically attach the warning label assembly 102 to the worksite safety device 5; and step three 503, attaching the warning label assembly 102 to the worksite safety device 5.

Method 500 may further comprise the step four 504, of configuring the elastic attachment member 110 to elastically attach the warning label assembly 102 to a worksite safety device 5 comprising at least one of a traffic cone 9, a safety barrel 11, a portable barricade 13. Additionally, it provides such a method 500, further comprising the step five 505, of forming the display member 106 from a flexible sheet material 112. Also, it provides such a method 500, further comprising the step six 506, of arranging the display member 106 to include a pocket 114, wherein the protective cover 108 comprises a transparent wall 118 of the pocket 114 and the pocket 114 is adapted to removably receive a sheet 116 containing the safety information 104.

In addition, method 500 may further comprise the step seven 507, of configuring the safety information 104 to includes at least one pictographic logo 120 depicting the worksite hazard 15. Moreover, method 500 may further include the step eight 508, of configuring the safety information 104 to include text 122 warning of the worksite hazard. Further, method 500, further comprising the step nine 509, of providing the text 122 in multiple languages. Even further, method 500 may further include the step ten 510, of providing contact information 124 within the safety information 104. Moreover, method 500 may further include the step eleven 511, of applying the safety information 104 on the display member 106 using a printing process 126. Additionally, it provides such a method 500, further comprising the step twelve 512, of applying the safety information 104 on the display member 106 by an etching process. Also, method 500 may further comprise the step thirteen 513, of forming the protective cover 108 from a flexible transparent sheet 116. In addition, method 500, may further comprising the step thirteen 513, of forming the protective cover 108 from a fluid-applied transparent coating 130. Furthermore, method 500 may include the step fourteen 514, of applying an adhesive 132 to the warning label assembly 102 to assist adhering the warning label assembly 102 to the worksite safety device 5. Further, method 500 may include the step fifteen 515, of providing an illuminated element 134 within the warning label assembly 102. Even further, method 500 may further comprise the step sixteen 516, of applying the safety information 104 directly to the worksite safety device 5.

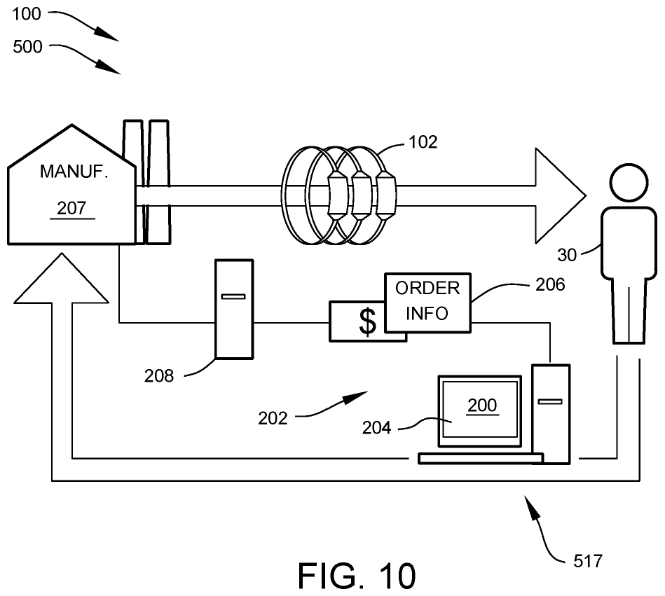

FIG. 10 is a diagram illustrating additional steps of method 500 related to using the warning-label system to produce custom warning labels, according to an embodiment of the present disclosure. Method 500 may further comprise the step seventeen 517, of: providing a website 200 operable on a client computer 203 operating on a computer network 202, the website 200 including a user 30 interface 204 adapted to enable user entry of the custom safety information 104, user entry of the type of worksite safety device 5, and user entry of order transaction information 206, providing a host computer 208 operable within the computer network 202, the host computer 208 adapted to receive the custom safety information 104, the type of worksite safety device 5, and the order transaction information 206 from the website 200, initiating production 207 of the warning label assembly 102 containing the custom safety information 104 and the elastic attachment member 110 usable attach the warning label assembly 102 to the type of worksite safety device 5 selected, and completing the order transaction defined by the order transaction information 206 received from the client computer 203.

It should be noted that some of the above-noted steps may be optional and may not be implemented in all cases. Optional steps of method 500 are illustrated using dotted lines in FIG. 9 so as to distinguish them from the other steps of method 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for custom warning-label system 100 (e.g., different step orders within the above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1) A method of use relating to a custom warning-label system to modify a worksite safety device comprising the steps of:
identifying a worksite hazard;
providing a warning label configured to display safety information relating to the worksite hazard, the warning label comprising
a display member configured to display the safety information,
a protective cover configured to protectively cover the display surface, and
an elastic attachment member configured to elastically attach the warning label to the worksite safety device; and
attaching the warning label to the worksite safety device.

2) The method of claim 1, further comprising the step of configuring the elastic attachment member to elastically attach the warning label to a worksite safety device comprising at least one of a traffic cone, a safety barrel, a portable barricade.

3) The method of claim 1, further comprising the step of forming the display member from a flexible sheet material.

4) The method of claim 1, further comprising the step of arranging the display member to include a pocket, wherein the protective cover comprises a transparent wall of the pocket and the pocket is adapted to removably receive a sheet containing the safety information.

5) The method of claim 1, further comprising the step of configuring the safety information to includes at least one pictographic logo depicting the worksite hazard.

6) The method of claim 1, further comprising the step of configuring the safety information to include text warning of the worksite hazard.

7) The method of claim 1, further comprising the step of providing the text in multiple languages.

8) The method of claim 1, further comprising the step of providing contact information within the safety information.

9) The method of claim 1, further comprising the step of applying the safety information on the display member using a printing process.

10) The method of claim 1, further comprising the step of applying the safety information on the display member by an etching process.

11) The method of claim 1, further comprising the step of forming the protective cover from a flexible transparent sheet.

12) The method of claim 1, further comprising the step of forming the protective cover from a fluid-applied transparent coating.

13) The method of claim 1, further comprising the step of applying an adhesive to the warning label to assist adhering the warning label to the worksite safety device.

14) The method of claim 1, further comprising the step of providing an illuminated element within the warning label.

15) The method of claim 1, further comprising the steps of:
providing a website operable on a computer network, the website including a user interface adapted to enable
user entry of the custom safety information,
user entry of the type of worksite safety device, and
user entry of order transaction information;
providing a host computer operable within the computer network, the host computer adapted to receive the custom safety information, the type of worksite safety device, and the order transaction information from the website;
initiating production of the warning label containing the custom safety information and the elastic attachment member usable attach the warning label to the type of worksite safety device selected; and
completing the order transaction defined by the order transaction information received from the client computer system.

16) The method of claim 1, further comprising the step of applying the safety information directly to the worksite safety device.

17) A custom warning-label system usable to modify a worksite safety device to display safety information relating to the worksite hazard, comprising:
a warning label configured, the warning label including
a display member configured to display the safety information;
a protective cover configured to protectively cover the display surface, and
an elastic attachment member configured to elastically attach the warning label to the worksite safety device; and
a set of instructions, wherein the custom warning-label system is arranged as a kit.
wherein the elastic attachment member is configured to elastically attach the warning label to a worksite safety device comprising at least one of a traffic cone, a safety barrel, a portable barricade; and
wherein the safety information includes
text warning of the worksite hazard; and
text containing contact information.

18) The custom warning-label system of claim 17, wherein the warning label further comprises an adhesive to assist adhering the warning label to the worksite safety device.

19) The custom warning-label system of claim 17, wherein
the protective cover comprises a transparent wall of the pocket; and
the pocket is adapted to removably receive a sheet containing the safety information.

20) The custom warning-label system of claim 17, wherein the safety information is applied on the display member using a printing process.
